(19) United States
(12) Patent Application Publication
(10) Pub. No.: US 2015/0094459 A1
(43) Pub. Date: Apr. 2, 2015

(54) Pretreatment of Lignocellulosic Biomass and Recovery of Substituents using Natural Deep Eutectic Solvents/Compound Mixtures with Low Transition Temperatures

(71) Applicants: Maaike Christine Kroon, Eindhoven (NL); Maria Francisco Casal, Koln (DE); Adriaan van den Bruinhorst, Eindhoven (NL)

(72) Inventors: Maaike Christine Kroon, Eindhoven (NL); Maria Francisco Casal, Koln (DE); Adriaan van den Bruinhorst, Eindhoven (NL)

(21) Appl. No.: 14/391,165

(22) PCT Filed: Apr. 12, 2013
(86) PCT No.: PCT/EP2013/057691

§ 371 Date: Oct. 7, 2014

Related U.S. Application Data
(60) Provisional application No. 61/623,306, filed on Apr. 12, 2012.

(51) Int. Cl. C07G 1/00

(52) U.S. Cl. CPC C07G 1/00
USPC 530/507; 530/500

(57) ABSTRACT

Low transition temperature mixtures (LTTMs) or solvents are provided that can be used in methods and systems to dissolve and bydrolyze certain components from lignin-containing biomass (e.g., lignin) at mild conditions so that further degradation is prevented. The solvents, methods and systems according to the invention have various advantages over prior technology or approaches. For example, LTTMs are cheap solvents, renewable and/or non-toxic food ingredients. LTTMs dissolve lignin selectively from a lignin-containing biomass. A highly efficient (up to 90%) lignin recovery can be achieved. The recovered lignin is of higher quality. The remaining cellulose is also of higher. Much less water is needed, which means a tremendous reduction of the energy requirement in the recovery process, i.e. less energy needed for evaporating large quantities of water.

### FIELD OF THE INVENTION

The invention relates to methods, devices, compounds and systems for the recovery of substituents, chemicals or fuels from a biomass.

### BACKGROUND OF THE INVENTION

Deep eutectic solvents (DESs) were presented by Abbott et al. (2004) for the first time as suitable alternative solvents compared to conventional ionic liquids (ILs). The main constituents of these eutectic mixtures are solids with high melting points that show strong hydrogen bonding interactions. The resultant combinations often provide wide liquid range and unusual low transition temperatures. The first reported DES was a mixture of urea and choline chloride. DESs can also be formed by mixing a quaternary ammonium or phosphonium salt acting hydrogen bond acceptor with a hydrogen bond donor agent, for instance, acids, alcohols, amines or carbohydrates. Most DESs share some of the promising solvent characteristics of ILs. They often show low volatility, wide liquid range, water-compatibility, non-flammability, non-toxicity, biocompatibility and biodegradability. Furthermore, they show the ability to customize their physical properties by choosing the right DES constituents in terms of chemical nature, relative compositions or water content. In addition, they can be prepared from readily available materials at high purities and low cost compared to ILs, and they can be considered as environmentally benign solvents. Because of keeping most of the advantages of ILs, but overcoming some of their limitations (e.g. ILs are expensive, difficult to synthesize, generally not biodegradable or renewable, and made from petrochemical resources), DESs open room to research in multiple applications. For instance, they have been successfully applied as solvents or catalysts for chemical reactions or biotransformations, metal electro-deposition, synthesis of nanoparticles, liquid and gas separations and heat transfer fluids. Still, a limitless variety of DESs and a wide range of possible applications are still to be discovered.

In a future bio-economy, finding a suitable solvent for lignocellulosic biomass has become the Achilles's heel of renewable biofuels processing. Conventional methods for biomass deconstruction into cellulose, hemicelluloses and lignin bioproducts often require extreme and expensive techniques (e.g. steam explosion, high temperatures, addition of strong acids/bases) resulting in degradation and the occurrence of undesired side reactions (e.g. the synthesis of hydroxymethylfurfural). Moreover, new IL technologies for large scale application still show limitations in terms of recoverability and cost.

The present invention overcomes at least some of the limitations of ILs in lignin separation and provides suitable Low Transition Temperature Mixtures (LTTMs) for lignin-containing biomass processing.

### SUMMARY OF THE INVENTION

The present invention provides low transition temperature mixtures (LTTMs) or solvents that can be used to dissolve and hydrolyze certain components from lignin-containing biomass (e.g. lignin) at mild conditions so that further degradation is prevented. Since other components in the lignin-containing biomass (e.g. cellulose) show much lower solubility in the LTTM type of solvents, they can be separated from the higher soluble components (e.g. lignin) in a very energy-efficient way. It is noted that in this invention, we are providing new types of (nature-based) deep eutectic solvents (DESs) or low transition temperature mixtures (LLTMs) and we are dissolving the lignin (and not the cellulose) from the lignin-containing biomass. Examples of a lignin-containing biomass are wood, wood residues, paper, straw, corn, stover, sugarcane, bagasse, saw mill discards, paper mill discards, municipal paper waste, or the like.

In one embodiment, the solvent has two or three renewable components that have a high melting point (ranging from 60 degrees Celsius to 400 degrees Celsius). The mixture has a much lower melting point (always lower than working temperature, and often even lower than room temperature).

Examples of LTTMs are mixture combinations of a hydrogen bond donor and a hydrogen bond acceptor, both of which are solids at about room temperature (which is defined in a temperature range of minus 50 degrees Celsius tot 60 degrees Celsius. The LTTM is a liquid within a first temperature range around room temperature. The first temperature range where the LTTM is a liquid is between about minus 50 degrees Celsius and about 150 degrees Celsius. In general, an LTTM, according to examples of the invention, contains at least one or more hydrogen bond donors and at least one or more hydrogen bond acceptor.

Examples of hydrogen bond acceptors are amino-acids, salts, organic salts or natural salts. Examples of hydrogen bond donors are urea, organic acids, alcohols, polyols, aldehydes, carbohydrates or saccharides. For example, LTTMs can be mixtures of salts with organic acids or amino acids (e.g. choline chloride+malic acid), mixtures of organic acids with amino acids (e.g. proline+malic acid), mixtures of salts with alcohols or aldehydes (e.g. choline chloride+glycerol) and mixtures of organic acids or amino acids with alcohols, carbohydrates or aldehydes (e.g. fructose+glucose+malic acid).

The solvents are used to dissolve lignin from a lignin-containing (e.g. lignocellulosic) biomass very selectively at moderate temperatures (about 60 degrees Celsius, or in a second temperature range of about 60 degrees Celsius to about 100 degrees Celsius), while cellulose and hemicelluloses do not dissolve. The first and second temperature ranges are designed since at lower temperatures the viscosity of the LLTM is too high making the dissolution kinetics too slow, and at higher temperatures the risk of LTTM decomposition become too high.

Accordingly, the solvent is able to separate lignin and cellulose in a very energy-efficient way without the occurrence of any degradation. The dissolved lignin and LTTM mixture can be separated from the solids remaining in the biomass by using a liquid/solid separation, filtration, sedimentation or centrifugation to separate the cellulose, hemicellulose, or both.

In another example, the remaining cellulose and hemicellulose can be hydrolyzed in the solvent at elevated temperatures (about 120 degrees Celsius). This is advantageous because of the catalytic activity of the LTTM (acidity) and because of the tolerance of the solvent for enzymes and its renewability.

The dissolved lignin can be recovered from the LTTM by addition of water to precipitate the dissolved lignin from the LTTM. The solvent itself can be recovered by separating off water or using an anti-solvent (e.g. acetone).

The solvents, methods and systems according to embodiments of the invention has various advantages over prior technology or approaches. For example.
LTTMs or DESs are cheap solvents, renewable and/or non-toxic food ingredients (e.g. sugars instead of conventional mixtures of urea with choline chloride);
LTTMs or DESs dissolve lignin selectively from a lignin-containing biomass;
A highly efficient (up to 90%) lignin recovery from a lignin-containing biomass can be achieved;
The recovered lignin is of higher quality compared to the recovered lignin in conventional, prior processes and can be valorized compared to being burned;
The remaining cellulose is of higher quality (less degradation, longer fibers due to milder process conditions) compared to the recovered cellulose is conventional, prior processes; and/or
Much less water is needed compared to conventional, prior processes, which means that the energy requirement in the recovery process is tremendously reduced, i.e. less energy needed for evaporating large quantities of water;

Aspects of the invention can be used as methods and system for various applications, such as:
Selective lignin dissolution and extraction;
Lignin valorization;
Pulp and paper making;
Cardboard industry;
Cellulose hydrolysis (e.g. to fermentable sugars);
Making inedible crops edible (e.g. by removing lignin parts that cannot be digested by animals); or
Chemical or fuel production.

### BRIEF DESCRIPTION OF THE DRAWINGS

FIG. 1 shows selected hydrogen bond donors and acceptors for the formation of low transition temperature mixtures according to exemplary embodiments of the invention. FIG. 2 shows according to exemplary embodiments of the invention malic acid-choline chloride mixtures showing the phase transition for different hydrogen bond donor-hydrogen bond acceptor molar ratios at room temperature.

FIG. 3 shows according to exemplary embodiments of the invention differential scanning calorimetry (DSC) curves for some representative mixtures described in Table 2 screened for lignin, cellulose and starch solubility.

FIG. 4 shows according to exemplary embodiments of the invention biomass processing with LC2:1 (top) and MP1:3 (bottom) at different stages: (A) wheat straw raw biomass samples, (B) after pretreatment with LTTM overnight, (C) after centrifuging and (D) after washing with ethanol and centrifuging.

FIG. 5 shows according to exemplary embodiments of the invention wheat straw biomass samples after pretreatment with and LC2:1 at 60 degrees Celsius (I) MP1:3 at 85 degrees Celsius (II) overnight.

FIG. 6 shows a flow diagram of a process according to an exemplary embodiment of the invention. DES stands for Deep Eutectic Solvent and LTTM stands for Low Transition Temperature Mixture.

### DETAILED DESCRIPTION

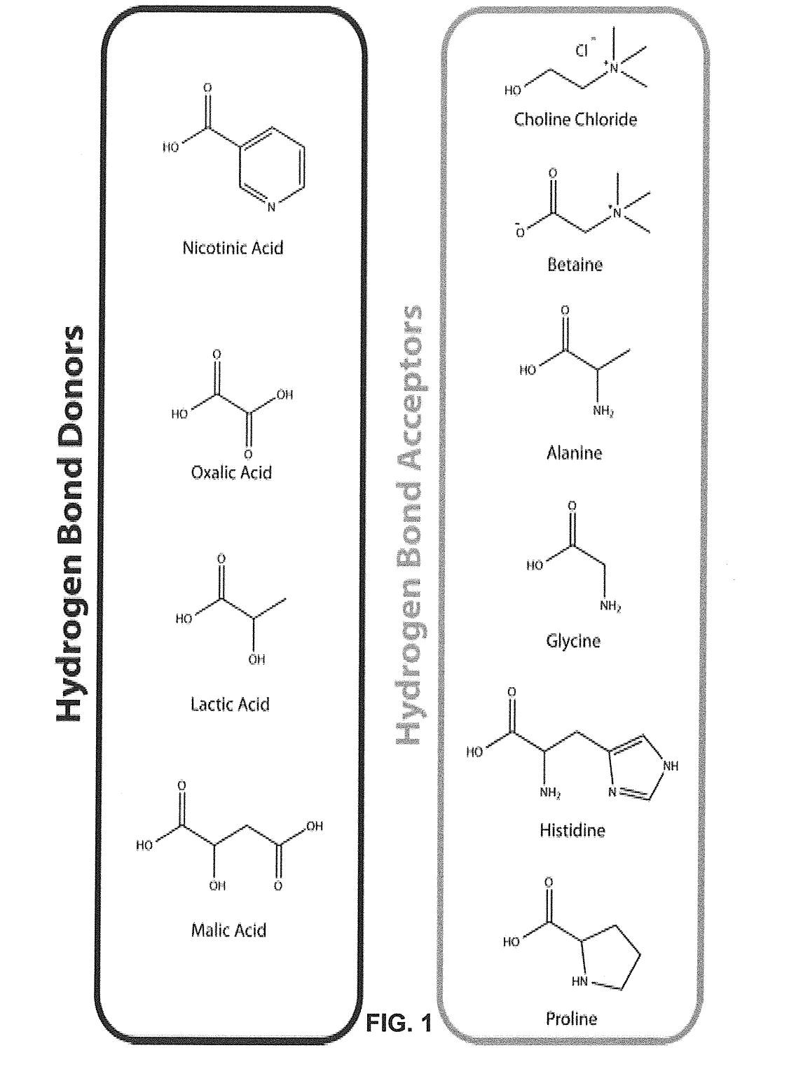

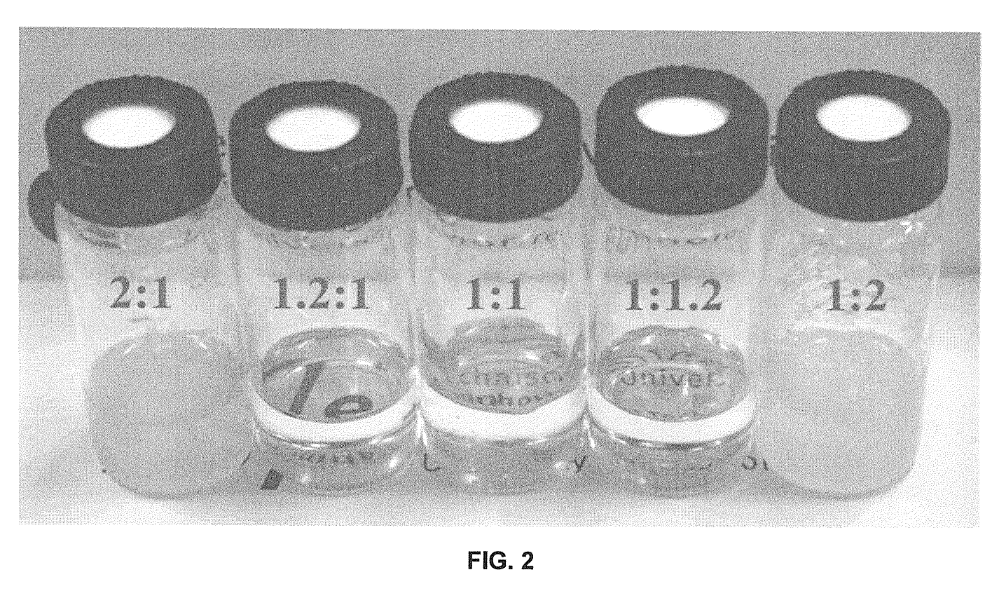

In the present invention, new low transition temperature mixtures (LTTMs) are provided by combining natural and renewable biomaterials as shown in FIG. 1. For the purposes of this invention, LTTMs are also referred to as deep eutectic solvents (DESs). Originally, these mixtures were called DESs, but this name does not cover the complete class of solvents, because many mixtures do not show (eutectic) melting points, but glass transitions instead.

The selection of starting materials was made on the basis of the available functional groups and the key interactions involved in lignocellulosic biomass dissolution. A set of representative natural amino acids with suitable structures and functional groups, some essential nutrients represented by choline chloride and nicotinic acid, as well as different natural acids present in fruits and vegetables were tested as liquid-phase promoters. In one example, the preparation of the new solvents was done by mixing both starting materials in the solid state, followed by melting them at 60 degrees Celsius for mixtures containing lactic or oxalic acid, or at 130 degrees Celsius for nicotinic and malic acid mixtures. It is noticeable that the melting temperature or glass transition temperature (as some mixtures do not show a melting point) was always found to be lower than the melting point of any of the starting materials. The higher the temperature during mixing and the better the mixing, the faster the melting was observed. Nevertheless, higher thermal stability was found for mixtures obtained at lower temperatures for longer times. Once a clear and transparent liquid was formed with no evidence of solid particles, the mixture was cooled down and differential scanning calorimetry (DSC) analysis was carried out to determine the phase transition temperature of the formed liquids. Water content was always less than 1 wt %. A more detailed description of an example of an experimental procedure is included infra in the section Supplemental Information.

Tables 1A-C show the ‘hydrogen bond donor’—‘hydrogen bond acceptor’ combinations, which were resulting in clear liquids (Table 1A), liquids at the set temperature but with formation of solid particles when cooling down (Table 1B), and with no evidence of melting for the selected combination or ratio (Table 1C).

TABLE 1A
Hydrogen bond donor-hydrogen bond acceptor mixtures
resulting in formation of clear DESs.

| Hydrogen Bond | | Hydrogen Bond |
|---|---|---|
| Donor | Molar Ratio | Acceptor |
| Lactic Acid | 9:1 | Alanine |
| Lactic Acid | 2:1 | Betaine |
| Lactic Acid | 1.3:1-15:1 | Choline Chloride |
| Lactic Acid | 1:9 | Glycine |
| Lactic Acid | 5:1-9:1 | Histidine |
| Lactic Acid | 1:1-4:1 | Proline |
| Malic Acid | 1:1 | Alanine |
| Malic Acid | 1:1 | Betaine |
| Malic Acid | 1:1.2-1.2:1 | Choline Chloride |
| Malic Acid | 1:1 | Glycine |
| Malic Acid | 1:1-2:1 | Histidine |
| Malic Acid | 9:1 | Nicotinic Acid |
| Malic Acid | 1:3-3:1 | Proline |
| Oxalic Acid (Anhydrous) | 1:1 | Alanine |
| Oxalic Acid (Anhydrous) | 1:1.5-1.5:1 | ChCl |
| Oxalic Acid (Anhydrous) | 1:1-1.5:1 | Proline |
| Oxalic Acid (Dihydrate) | 2:1 | Alanine |
| Oxalic Acid (Dihydrate) | 1:1 | Betaine |
| Oxalic Acid (Dihydrate) | 1:1 | Choline Chloride |
| Oxalic Acid (Dihydrate) | 1:1-3:1 | Glycine |
| Oxalic Acid (Dihydrate) | 1:1 | Histidine |
| Oxalic Acid (Dihydrate) | 1:1 | Proline |
| Oxalic Acid (Dihydrate) | 9:1 | Nicotinic Acid |

TABLE 1B
Hydrogen bond donor-hydrogen bond acceptor mixtures resulting
in precipitation of solid particles when cooling down.

| Hydrogen Bond Donor | Molar Ratio | Hydrogen Bond Acceptor |
|---|---|---|
| Lactic Acid | 1:1.2-1.2:1 | Choline Chloride |

TABLE 1C
Hydrogen bond donor-hydrogen bond acceptor
mixtures resulting in no melting.

| Hydrogen Bond | | Hydrogen Bond |
|---|---|---|
| Donor | Molar Ratio | Acceptor |
| Lactic Acid | 1:1 | Alanine |
| Lactic Acid | 1:1 | Betaine |
| Lactic Acid | 1:2-1:1.4 | Choline Chloride |
| Lactic Acid | 1:1 | Glycine |
| Lactic Acid | 2:1 | Histidine |
| Lactic Acid | 1:2 | Proline |
| Malic Acid | 1:2 | Choline Chloride |
| Malic Acid | 2:1 | Choline Chloride |
| Oxalic Acid (Anhydrous) | 1:1 | Betaine |
| Oxalic Acid (Anhydrous) | 1:1 | Glycine |
| Oxalic Acid (Anhydrous) | 1:1-4:1 | Histidine |
| Oxalic Acid (Dihydrate) | 1:1 | Alanine |
| Nicotinic Acid | 1:1 | ChCl |
| Nicotinic Acid | 1:1 | Proline |

The building principles are not easy to generalize. Unlike normal chemical bonds, hydrogen bonds present different contact distances and binding energies which do not depend only on the donor and acceptor nature. FIG. 2 shows exemplary images of the evolution of the phase transition for the malic acid-choline chloride series shown in Tables 1A-C.

The proton affinity (PA)/pKₐ equalization plays a role in strengthening the H-bond, so the pKₐ slide rule was taken into account in the selection of the H-bonding counterparts. The pKₐ values for the main functional groups are included in FIG. 1. The acidity of the proton is also responsible for the formation of an LTTM instead of an IL. For instance, when lactic acid is combined with choline chloride, a liquid is formed at room temperature. However, the ionic liquid choline lactate is not produced as reflected in IR spectra (not shown). An IL is a liquid below 100° C., solely having ions. For the IL to be formed, a stronger base with a higher pKₐ needs to be facing the H-bond donor or a stronger acid needs to be facing the acceptor. Hydrogen bonding can be evidenced as well by the shifts in the representative peaks of the involved bonds in the Fourier Transform Infrared Spectroscopy (FTIR) spectra. A shift in the resonance signal can also be noticed to lower field in ¹H-NMR (spectra not shown).

Table 2 captures the transition temperatures of the selected mixtures.

TABLE 2
Selection of solvents for screening of biopolymer solubilities,
including glass transition temperatures (degrees Celsius).

| | Hydrogen Bond | | Hydrogen Bond | |
|---|---|---|---|---|
| Name | Donor | Ratio | Acceptor | Tg |
| LA9:1 | Lactic Acid | 9:1 | Alanine | −59.31 |
| LB2:1 | Lactic Acid | 2:1 | Betaine | −46.86 |
| LC1.3:1 | Lactic Acid | 1.3:1 | Choline Chloride | −76.75 |
| LC2:1 | Lactic Acid | 2:1 | Choline Chloride | −77.73 |
| LC5:1 | Lactic Acid | 5:1 | Choline Chloride | −69.23 |
| LC10:1 | Lactic Acid | 10:1 | Choline Chloride | −66.3 |
| LG9:1 | Lactic Acid | 9:1 | Glycine | −54.51 |
| LH9:1 | Lactic Acid | 9:1 | Histidine | −39.22 |
| LP2:1 | Lactic Acid | 2:1 | Proline | −36.69 |
| MA1:1 | Malic Acid | 1:1 | Alanine | −42.64 |
| MB1:1 | Malic Acid | 1:1 | Betaine | −20.01 |
| MC1:1 | Malic Acid | 1:1 | Choline Chloride | −56.48 |
| MG1:1 | Malic Acid | 1:1 | Glycine | −34.08 |
| MP1:1 | Malic Acid | 1:1 | Proline | −13.64 |
| MP1:2 | Malic Acid | 1:2 | Proline | −15.51 |
| MP1:3 | Malic Acid | 1:3 | Proline | −44.38 |
| MH2:1 | Malic Acid | 2:1 | Histidine | — |
| MN9:1 | Malic Acid | 9:1 | Nicotinic Acid | — |
| OB1:1 | Oxalic Acid Dihydrate | 1:1 | Betaine | −17.19 |
| OP1:1 | Oxalic Acid Dihydrate | 1:1 | Proline | −42.91 |
| OC1:1 | Oxalic Acid Dihydrate | 1:1 | Choline Chloride | −40.17 |
| OG3:1 | Oxalic Acid Dihydrate | 3:1 | Glycine | — |
| ON9:1 | Oxalic Acid Dihydrate | 9:1 | Nicotinic Acid | — |
| OH9:1 | Oxalic Acid Dihydrate | 9:1 | Histidine | — |
| OCA1:1 | Oxalic Acid Anhydrous | 1:1 | Choline Chloride | −46.06 |
| OPA1:1 | Oxalic Acid Anhydrous | 1:1 | Proline | −14.45 |

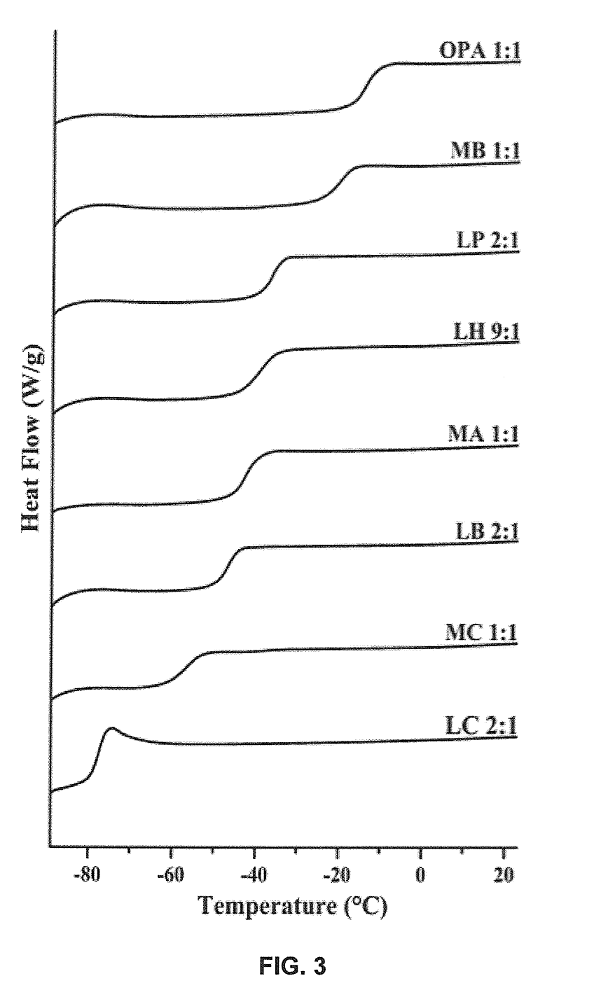

These values are significantly lower compared with the melting point of the starting materials. Some representative DSC curves can be found in FIG. 3 showing unusual low glass transition temperatures. Because for the selected mixtures no melting point was found, but most of the mixtures showed glass transitions instead, we named them LTTMs instead of DESs.

Biomass processing faces two main challenges for a better exploitation of lignocellulosic biomass. The first challenge pertains to the recalcitrant nature of lignocellulosic biopolymers, making them difficult to dissolve. The second challenge is the efficient hydrolysis into sugars or high-valuable products. In both cases, the solvent plays a crucial role. In this context, 26 new mixtures, listed in Table 2, are screened as solvents for lignin, cellulose and starch.

The importance of this screening lies in the evaluation of the potential ability of LTTMs to deconstruct the lignocellulosic biomass structure. High to selectivity is desirable for separating lignin from cellulose and hemicellulose, and high solubility leads to efficient hydrolysis. Two different approaches can be considered for the hydrolysis with these solvents: catalytic or enzymatic hydrolysis. For catalytic hydrolysis, LTTMs are likely to act as solvents as well as catalysts or co-catalysts, considering their acid character.

They can also be designed to be an enzyme-tolerant medium which allows the development of a one-pot process where both deconstruction and enzymatic hydrolysis occur.

Achieving good solubilities is a must for catalytic hydrolysis of cellulose or hemicellulose, while delignification and decrystallization are desirable for enzymes to perform better. In all cases, the biorenewable and natural character of the solvent constituents is of most importance.

For further steps in the process, the recoverability of the solvent is considered. Solvents that are able to form hydrogen bonding are very likely to phase separate when adding a non-hydrogen bonding solvent. As an example, acetone was proved to work as an anti-solvent for solvent recoverability. The experimental procedure is described infra in the section Supplemental Information.

Cellulose and lignin are the two most abundant renewable polymers in lignocellulosic biomass, and starch is chosen as the representative polysaccharide for this study. For a selection of 26 solvents, listed in Table 3, the solubility of these biopolymers was determined by using the cloud point method. Vials containing 2 g of solvent were placed in an oil bath. The selected temperature (Tₜₑₛₜ) was set constant for the whole experiment. Consecutive additions of 0.2-1 mg of solute were done under vigorous stirring to ensure good contact between phases. Once the turbidity or the presence of particles was noticeable by the cloud point method, the samples were equilibrated for at least 24 hours to check that the turbidity had not disappeared. Zero solubility was considered when the addition of 0.1 wt % of solute showed turbidity. The dissolution temperature was set as 60° C. for less viscous mixtures and as 100° C. for the ones showing higher viscosity.

TABLE 3
Solubility values in wt % for lignin, starch
and cellulose for the selected LTTMs.

| Name | Tₜₑₛₜ(° C.) | Lignin | Starch | Cellulose |
|---|---|---|---|---|
| LP2:1 | 60 | 7.56 | 0.00 | 0.00 |
| LB2:1 | 60 | 12.03 | 0.00 | 0.00 |
| LC1.3:1 | 60 | 4.55 | 0.00 | 0.00 |
| LC2:1 | 60 | 5.38 | 0.00 | 0.00 |
| LC5:1 | 60 | 7.77 | 0.00 | 0.00 |
| LC10:1 | 60 | 11.82 | 0.13 | 0.00 |
| LH9:1 | 60 | 11.88 | 0.13 | 0.00 |
| LG9:1 | 60 | 8.77 | 0.00 | 0.00 |
| LA9:1 | 60 | 8.47 | 0.26 | 0.00 |
| MA1:1 | 100 | 1.75 | 0.59 | 0.11 |
| MB1:1 | 100 | 0.00 | 0.81 | 0.00 |
| MC1:1 | 100 | 3.40 | 7.10 | 0.00 |
| MG1:1 | 100 | 1.46 | 7.65 | 0.14 |
| MP1:1 | 100 | 0.00 | 0.00 | 0.00 |
| MP1:2 | 100 | 6.09 | 0.32 | 0.24 |
| MP1:3 | 100 | 14.90 | 5.90 | 0.78 |
| MH2:1 | 85 | 0.00 | 0.00 | 0.00 |
| MN9:1 | 85 | 0.00 | 0.00 | 0.00 |
| OB1:1 | 60 | 0.66 | 0.00 | 0.00 |
| OP1:1 | 60 | 1.25 | 0.00 | 0.00 |
| OC1:1 | 60 | 3.62 | 2.50 | 0.00 |
| OG3:1 | 85 | 0.28 | 0.00 | 0.00 |
| ON9:1 | 60 | 0.00 | 2.83 | 0.00 |
| OH9:1 | 60 | 0.00 | 0.00 | 0.25 |
| OCA1:1 | 60 | 0.00 | 0.15 | 0.00 |
| OPA1:1 | 60 | 0.00 | 0.15 | 0.15 |

From Table 3 it can be observed that a high selectivity for the separation of lignin from a mixture of lignin and cellulose was found. Furthermore, very different solubility values were obtained for the different combinations. Choline chloride-lactic acid mixtures show high solubility for lignin, while cellulose was found to be immiscible with the whole series. Lignin solubility shows in this case a clear trend when increasing the acid content (LC1.3:1<LC2:1<LC3:1<LC5:1<LC9:1)

However, the opposite trend was found when comparing with the malic acid-proline series (MP1:1<<MP1:2<MP1:3). The malic acid combinations, in general, were found to show much higher solubilities for starch and lower solubilities for lignin when comparing with other hydrogen bond donors. But for the former series, an increase in solubility of cellulose (also of lignin and starch) was found when increasing the proline ratio. The role of the hydrogen bond acceptor opens room to further discussion.

Depending on the selected donor, the trend in solubilities can be inverted. For instance, lignin solubility shows the trend LB>LH>LC>LG>LA>LP for the lactic acid sequence, while malic or oxalic acid follows MP>MC>MG>>MH≈MN≈MN≈MB and OC>OP>OB>OG≈PH≈ON, respectively.

Even though cellulose solubility was found to be very poor or negligible for most of the studied solvents, there was a noticeable change in cellulose crystallinity in most cases, obtaining a turbid liquid after stirring overnight. In the case of lactic acid-choline chloride mixtures for example, the cellulose fibers were not dissolved, but for the mixtures containing proline, only a new turbid liquid phase was formed with no evidence of solid particles.

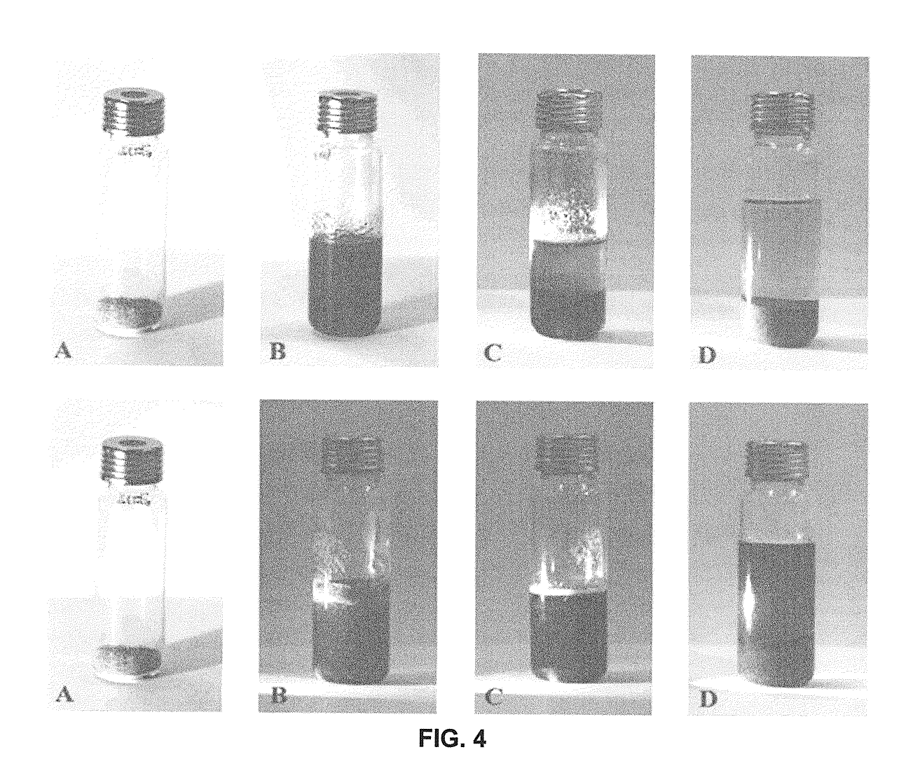

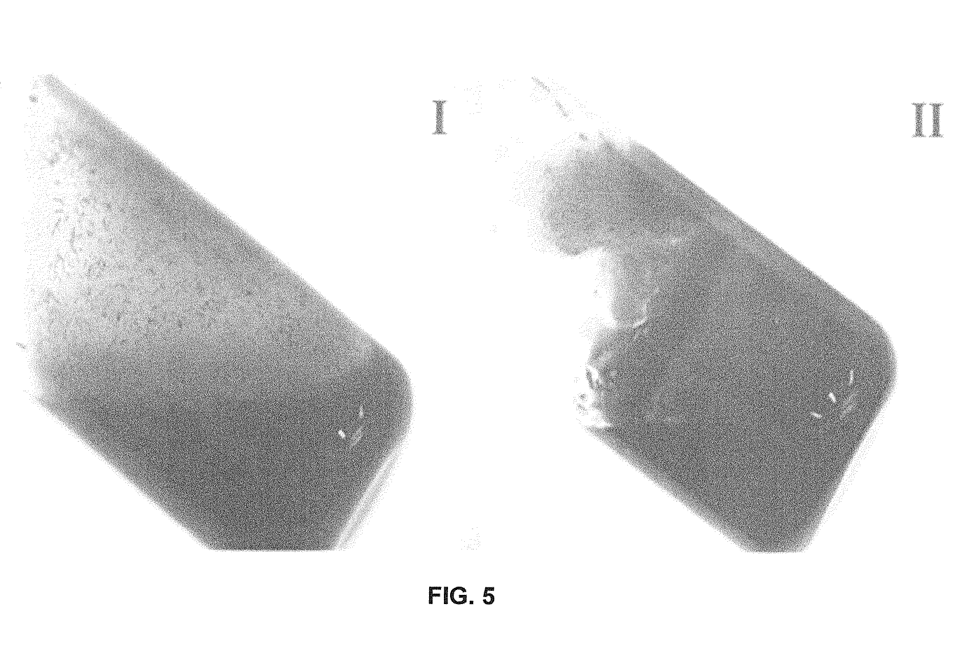

Experiments were done to test the solubility of real wheat straw biomass samples. For the first experiment, wheat straw biomass was suspended in the LC2:1 LTTM. The LTTM colored upon stirring the biomass suspension overnight, although biomass particles or fibers were still present (FIGS. 4 and 5). After three washing cycles with ethanol, 90.5 wt % of the non-dissolved biomass could be recovered.

Direct separation of the suspended and dissolved biomass was done by centrifuging the LC2:1 with biomass without washing. FIG. 4 shows the processed material after each one of the described steps.

After washing, 81.6% and 2.0 wt % of the added biomass was recovered from the separated precipitate and supernatant respectively, which means that 2 wt % of the biomass can be considered as being dissolved and composed entirely of lignin.

A second experiment was done following the same procedure for MP1:3. In this case, much less biomass particles can be noticed after the pretreatment (FIGS. 4 and 5). This result is consistent with the higher values reported for the solubilities of cellulose and starch. Lignin is soluble in higher extension, as reflected in the color change of the solvent.

Supplemental Information

Example of Screening of LTTMs DL malic acid, was provided by Merck Chemicals (≧99%), lactic acid was obtained at pharmaceutical grade from PURAC Biochem BV, and the other chemicals were obtained from Sigma-Aldrich (≧98%). Choline chloride and lactic acid (both hygroscopic) were dried under vacuum before use.

The required preparation temperature for the LTTMs depends on the lowest melting point of the constituents. Both hydrogen bond donor and acceptor starting materials were added to a closed 25 ml flask provided with magnetic stirring, and which temperature was controlled by using a thermostatic oil bath set to 60-130 degrees Celsius.

Both starting components where homogeneously mixed into the flask and set into the heating bath until the melting of the mixture provides enough liquid to initiate the magnetic stirring. The melting point of the mixture is always found to be much lower than the melting point of the starting materials. The better the mixing of the solid starting materials the less heating is required for melting.

Once the mixture forms a transparent liquid, it is cooled down and a TGA analysis was carried out to check the thermal stability. The water content was measured with Karl-Fisher titration method on a Metrohm 870 KF Titrino plus.

The glass transitions and melting points were analyzed by a Q20 TA instruments differential scanning calorimeter (DSC).

TABLE 4
Product information of the lignin
used in the solubility experiments.

| | Alkali Lignin, low |
|---|---|
| Name | sulfonate content |
| Sigma-Aldrich product nr. | 471003 |
| average M_{w} | ~10,000 |
| total impurities | 4% sulfur |
| pH | 10.5 (3 wt. %) |

Lignin (96%, Alkali lignin, low sulfonate content), cellulose (90%) and starch (practical grade) were purchased from Sigma-Aldrich. More details about the lignin used in these experiments are provided in Table 4. The Solubility of the biopolymers was determined by cloud point method. Vials containing 2 g of solvent were placed into an oil bath at constant temperature: 60 degrees Celsius for less viscous mixtures and 80 or 100 degrees Celsius for the ones showing higher viscosities. Consecutive additions of 0.2-1 mg of solute were made while keeping vigorous stirring. Once turbidity was noticeable, the samples were equilibrated for 24 hours. If the sample did not become clear, cloud point was registered; below 0.1 wt % no solubility was considered.

Example of Lignin and LTTM Regeneration Screening

Recoverability of the solvent after lignin subtraction is desirable; therefore a screening for suitable anti-solvents was done. Water and ethanol are likely to precipitate the lignin from the LTTMs. First, the miscibility of LTTM with water and ethanol (mixtures) was tested, finding complete miscibility. Then ethanol, water and their combinations (3:7, 1:1, 7:3 [v:v]) were added to saturated solutions of LC2:1 and lignin. Precipitation occurred and after centrifuging the supernatant became colored but transparent. To get an overview of which antisolvent is working the best for each LTTM and in which ratios, more experiments need to be done. Solvents with strong hydrogen bonding are likely to separate from non hydrogen bonding solvents. For this reason LC2:1 and acetone were mixed. Direct precipitation of the LTTM occurred when adding LC2:1 to acetone, while a two liquid phase system appeared when adding acetone to pure LC2:1. This implies that the pure LTTM or its starting materials in principle are able to be (partially) recovered.

Example of a Process and System

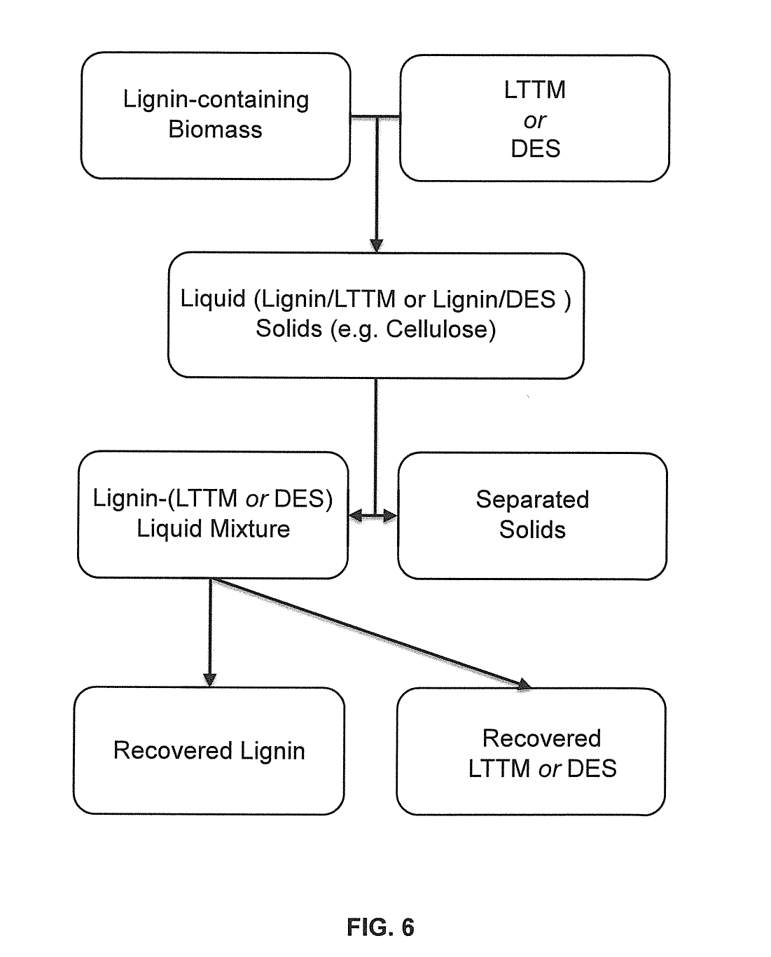

As shown in FIG. 6, after dissolving the lignin from the biomass using a suitable LTTM or DES, the remaining solids are separated off with a suitable solid-liquid separation step (such as filtration or sedimentation/centrifugation). These solids are mainly long fibers of cellulose and hemicellulose (a so-called (hemi)cellulose enriched phase). These solids have value themselves as pulp, or could be further hydrolyzed to fermentable sugars. Any traces of adhering LTTM or DES should not be a problem. In fact, LTTMS or DESs can even act as solvents for both catalytic and enzymatic hydrolysis of the (hemi)cellulose enriched phase considering their acid character and the fact that they can be designed to be an enzyme-tolerant medium, which allows the development of a one-pot process where both deconstruction and enzymatic hydrolysis occur.

The dissolved lignin can be recovered from the LTTM or DES phase by water addition. Lignin is by definition not soluble in water, and therefore water acts as an anti-solvent for lignin. This means that lignin will precipitate out of the LTTM or DES solution by water addition. Another solid-liquid separation step (such filtration or sedimentation/centrifugation) is needed to remove the solid lignin from the remaining DES-water mixture or LTTM-water mixture. This lignin has higher quality than the lignin from conventional pulping processes, and could be valorized in different ways. It can not only be thermally recycled (the conventional way to get rid of the lignin), but be converted to more valuable chemicals such as phenols.

The remaining (LTTM or DES)-water mixture can be disposed (both water and DES are generally cheap). But, the process can even be more economical if the DES is recycled in an energy-efficient way. There are several options available. Evaporation of the water is a possibility if the amount of water to be distilled off is small. Otherwise, the LTTM or DES can be recovered from the water by adding a nonhydrogen bonding solvent. As an example, acetone was proven to work as an anti-solvent for DES recoverability. The LTTM or DES precipitated and could be separated off as a solid. After heating, the LTTM or DES turned liquid and could be reused. The only energy requirement was then the separation of acetone from water by distillation, allowing also for the water and the acetone to be reused.

As a system the invention can be embodied with the following devices to perform the process steps:
An extractor for lignin extraction/dissolution from biomass with an LTTM or DES.
A filter or centrifuge for cellulose removal.
A mixer for water addition to the DES-lignin mixture.
A filter or centrifuge for precipitated lignin removal.
Either an evaporator or distillation column for water removal from LTTM or DES, or (i) a mixer for acetone addition to (LTTM or DES)-water mixture, (ii) a filter or centrifuge for LTTM or DES removal as solid, and (iii) a heater for LTTM or DES regeneration.
An evaporator or distillation column for acetone removal from water.

Notes on LTTM/DES and IL Solvents for Lignin

The present invention uses low transition temperature mixtures (LTTMs) and deep eutectic solvents (DESs) in the process to dissolve lignin from a biomass. Ionic liquids have been used as solvents in previous works but they are different in many ways. For example, ILs dissolve all the biomass (e.g. wood is completely dissolved, both the lignin and cellulose). After the use of ILs the process involves precipitation of cellulose so it can be filtered off. The lignin is then recovered by acetone evaporation (not by precipitation followed by a solid-liquid separation step as taught in this invention).

In summary, prior art teachings using ILs are different from the teachings of this invention when a LTTM or DES is used. For example:
Different solvents are used (ILs versus DES or LTTMs);
There are different solubilities, i.e. cellulose dissolves when using ILs, whereas it does not dissolve when using a DES or LTTM);
There is a different order of recovery (first the lignin when using the process with LTTMs or DESs or first the cellulose when using the process with ILs)
There is a different way of recovering lignin (by precipitation/solid-liquid separation as taught in this invention or by evaporation of acetone when ILs are used .

This application claims the benefit of U.S. provisional application 61/6233,306 filed Apr. 12, 2012, which is hereby incorporated for everything it teaches.

### REFERENCES

A. P. Abbott, D. Boothby, G. Capper, D. L. Davies and R. K. Rasheed, J. Am. Chem. Soc., 2004, 126, 9142.
A. P. Abbott, G. Capper, D. L. Davies, R. K. Rasheed and V. Tambyrajah, Chem. Commun., 2003, 70.
Y. H. Choi, J. V. Spronsen, Y. Dai, M. Verberne, F. Hollmann, I. W. C. E. Arends, G.-J. Witkamp and R. Verpoorte, Plant Physiol., 2011, 156, 1701.
M. A. Kareem, F. S. Mjalli, M. A. Hashim and I. M. AlNashef, J. Chem. Eng. Data, 2010, 55, 4632.
A. Abbott, R. C. Harris, K. S. Ryder, C. D′Agostino, L. F. Gladdenb and M. D. Mantleb, Green Chem., 2011, 13, 82.
P. Dominguez de Maria and Z. Maugeri, Cum Opin. Chem. Biol., 2011, 15, 220.
G. Saravanan and S. Mohan, J. Alloys Compd., 2012, 522, 162.
H.-G. Liao, Y.-X. Jiang, Z.-Y. Zhou, S.-P. Chen and S.-G. Sun, Angew. Chem., Int. Ed., 2008, 47, 9100.
M. A. Kareem, F. S. Mjalli, M. Ali Hashim and I. M. AlNashef, Fluid Phase Equilib., 2012, 314, 52.
A. P. Abbott, G. Capper, D. L. Davies, R. K. Rasheed and P. Shikotra, Inorg. Chem., 2005, 44, 6497.
X. Li, M. Hou, B. Han, X. Wang and L. Zou, J. Chem. Eng. Data, 2008, 53, 548.
R. B. Leron and M.-H. Li, Thermochim. Acta, 2012, 530, 52.
N. Sun, H. Rodriguez, M. Rahman and R. D. Rogers, Chem. Commun., 2011, 47, 1405.

What is claimed is:

1. A method of separating lignin from a lignin-containing biomass, comprising:
(a) having said lignin-containing biomass;
(b) having a low transition temperature mixture (LTTM), wherein said LTTM is a combination of a hydrogen bond donor and a hydrogen bond acceptor, both of which are solids at about room temperature, and wherein said LTTM is a liquid within a first temperature range around said room temperature;
(c) dissolving lignin of said lignin-containing biomass into said LTTM at a temperature within a second temperature range;
(d) separating said dissolved lignin and said LTTM from solids remaining in said biomass; and
(e) recovering said dissolved lignin from said LTTM.

2. The method as set forth in claim 1, wherein said step of separating said dissolved lignin and said LTTM comprises liquid/solid separating, filtrating, sedimentating or centrifugating to separate cellulose or hemicellulose.

3. The method as set forth in claim 1, wherein said step of recovering said dissolved lignin from said LTTM further comprises adding water to precipitate said dissolved lignin from said LTTM.

4. The method as set forth in claim 1, further comprising recovering said LTTM by separating off water or using an anti-solvent.

5. The method as set forth in claim 4, wherein said anti-solvent is acetone.

6. The method as set forth in claim 1, wherein said lignin-containing biomass is wood, wood residues, paper, straw, corn, stover, sugarcane, bagasse, saw mill discards, paper mill discards, or municipal paper waste.

7. The method as set forth in claim 1, wherein said hydrogen bond acceptor is an amino-acid, a salt, an organic salt or a natural salt.

8. The method as set forth in claim 1, wherein said hydrogen bond donor is urea, an organic acid, an alcohol, a polyol, or an aldehyde.

9. The method as set forth in claim 1, wherein said about room temperature is a temperature between minus 50 degrees Celsius to 60 degrees Celsius.

10. The method as set forth in claim 1, wherein said first temperature range, wherein said LTTM is a liquid, is between about minus 50 degrees Celsius and about 150 degrees Celsius.

11. The method as set forth in claim 1, wherein said second temperature range for said dissolution of said lignin is between about 60 degrees Celsius and about 100 degrees Celsius.

12. The method as set forth in claim 1, wherein said LTTM contains more than one hydrogen bond donor or hydrogen bond acceptor.
